(19) United States
(12) Patent Application Publication
(10) Pub. No.: US 2004/0249873 A1
(43) Pub. Date: Dec. 9, 2004

(54) Ultra fast comparator and method therefor

(75) Inventors: Moshe Stark, Even Yehuda (IL); Eyal Shachrai, Netanya (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: HyWire Ltd.

(21) Appl. No.: 10/454,540

(22) Filed: Jun. 5, 2003

(51) Int. Cl. G06F 7/00

(52) U.S. Cl. 708/207

(57) ABSTRACT

A multiple-stage comparator for comparing N-bit binary numbers, including: (a) a device for splitting each of the N-bit (N≧1) binary numbers into segments, and (b) computer implemented comparator units having: (i) at least two inputs containing information on a first segment, (ii) a processor having processing logic for examining and evaluating the information, so as to provide comparative information on at least the first segment, the comparative information including at least one result selected from the group consisting of a produced equality result and a produced inequality result, and (iii) at least one output containing the result, wherein a first plurality of the comparator units is logically disposed in parallel with respect to one another, and wherein at least a second plurality of the comparator units is logically disposed in series with respect to one another.

### FIELD AND BACKGROUND OF THE INVENTION

The present invention relates to comparators, and, in particular, to a comparator and method for utilizing the comparator so as to boost computer processing performance while maintaining reasonable hardware requirements.

Comparisons of large binary numbers are required in a wide range of applications, such as computer processing and control, and data search and processing in large information bases. In particular, such comparisons are extensively performed in various devices disclosed in some of my previous patent applications, such as the Binary Content Addressable Memory device taught by U.S. patent application Ser. No. 10/229,054 and the RAM-Based Range Content Addressable Memory device taught by U.S. patent application Ser. No. 10/229,065.

Comparators of large binary numbers are generally designed to perform serial comparisons of sequential bits, starting from the most significant bit and ending in the least significant bit. The worst-case time delay needed to complete the serial comparisons of all the sequential bits must be considered for synchronization purposes. This time delay significantly hinders the performance of computers, search processors and other related devices.

There is therefore a recognized need for, and it would be highly advantageous to have, an ultra fast comparator that appreciably increases processing performance. It would be of further advantage if such a comparator would increase processing performance while maintaining reasonable hardware requirements.

### SUMMARY OF THE INVENTION

The present invention is an ultra-fast comparator and method for utilizing such a comparator so as to boost processing performance, while maintaining modest hardware requirements.

According to the teachings of the present invention there is provided a multiple-stage comparator for comparing N-bit binary numbers, including: (a) a device for splitting each of the N-bit binary numbers into at least two segments, wherein N is an integer greater than 1, and (b) a plurality of computer implemented comparator units, each of the comparator units having: (i) at least two inputs containing information on a first segment of the segments, (ii) a processor having processing logic for examining and evaluating the information, so as to provide comparative information on at least the first segment, the comparative information including at least one result selected from the group consisting of a produced equality result and a produced inequality result and (iii) at least one output containing the result, wherein a first plurality of the comparator units is logically disposed in parallel with respect to one another, and wherein at least a second plurality of the comparator units is logically disposed in series with respect to one another.

According to further features in the described preferred embodiments, the first plurality of the comparator units is logically disposed such that each of the first plurality of the comparator units handles a single bit of the N-bit binary numbers.

According to still further features in the described preferred embodiments, the first stage of the comparator units is designed and configured to receive and compare the segments of the N-bit binary numbers, and wherein a second stage of the comparator units is designed and configured to receive at least one output of the comparator units in the first stage.

According to still further features in the described preferred embodiments, in at least a portion of the comparator units, at least two inputs containing information on the first segment include at least: (i) a first set of inputs containing information on the first segment of the N-bit binary numbers and (ii) a second set containing information on a second segment of the N-bit binary numbers, each set including: (A) a first input indicating an equality result, and (B) a second input indicating an inequality result, and wherein the processing logic within the portion of the comparator units generates comparative information on at least a portion of each of the N-bit binary numbers, the comparative information including both a produced equality result and a produced inequality result, and wherein at least one output includes a first output indicating the produced equality result, and a second output indicating the produced inequality result.

According to still further features in the described preferred embodiments, the first plurality of the comparator units is logically disposed such that each of the first plurality of the comparator units handles the segments of the N-bit binary numbers, each of the segments having a number of bits that is a submultiple of N.

According to still further features in the described preferred embodiments, the splitting device is configured to split the two N-bit binary numbers into N single-bit numbers, so as to produce pairs of the single-bit numbers, each pair of the pairs being compared in parallel in the first stage.

According to still further features in the described preferred embodiments, the number N of the two N-bit binary numbers satisfies an equation N=2ⁿ, wherein n is an integer greater than 1, and wherein outputs of two comparator units in a first stage are introduced to one comparator unit in the following stage.

According to still further features in the described preferred embodiments, the comparator units within the multiple-stage comparator are arranged such that a comparison of the two N-bit binary numbers is achieved in n+1 stages.

According to still further features in the described preferred embodiments, the number N of the two N-bit binary numbers satisfies an equation 2ⁿ⁻¹<N<2ⁿ, wherein n is an integer greater than 1, and wherein N can be represented by a sum of terms N=Nₙ₋₁·2ⁿ⁻¹+Nₙ₋₂·2ⁿ⁻²+ . . . +N₁·2¹+N₀, wherein at least two of the terms are non-zero. Each of the two N-bit binary numbers are split into N single-bit numbers, and the N pairs of single-bit numbers are compared using N parallel comparator units in the first stage. Each set of K (=2^{k}) pairs of single-bit numbers corresponding to each term of the form Nₖ·2^{k} (in the above expression for N) are handled in parallel by a comparator block having K comparator units in its first stage. The outputs of each pair of comparator units in the first stage of the comparator block are connected to one comparator unit in the following stage of the block. The outputs of each pair of comparator units in each following stages of the block are connected to the inputs of a comparator unit in the succeeding stage. The outputs of the comparator blocks are recursively connected to comparator units to provide two single-bit outputs in the last stage of the multiple-stage comparator. The comparator blocks and comparator units within the multiple-stage comparator are arranged such that a comparison of the two N-bit binary numbers is achieved in n+1 stages.

According to still further features in the described preferred embodiments, the produced equality result is defined by: EQ=EQ₁·EQ₀, wherein: EQ is the produced equality result; EQ₁ is the equality result of the first set of the inputs, and EQ₀ is the equality result of the second set of the inputs.

According to still further features in the described preferred embodiments, the produced inequality result is defined by: NEQ=NEQ₁+EQ₁·NEQ₀, wherein: NEQ is the produced inequality result; NEQ₁ is the inequality result of the first set of the inputs; NEQ₀ is the inequality result of the second set of the inputs, and EQ₁ is the equality result of the first set of the inputs, wherein the first set corresponds with the first segment of the N-bit binary numbers and the second set corresponds with the second segment of the N-bit binary numbers, and wherein the first segment contains more significant bits with respect to the second segment.

According to still further features in the described preferred embodiments, the produced inequality result is a greater than (GT) result.

According to still further features in the described preferred embodiments, the produced inequality result is a less than (LT) result.

According to still further features in the described preferred embodiments, the at least two sets of inputs include at least three sets of inputs.

According to yet another aspect of the present invention there is provided a comparator device for comparing two N-bit binary numbers, the device including: (a) at least one computer implemented comparator unit having: (i) at least two sets of inputs, each set of the sets containing information on a respective segment of the N-bit binary numbers, the sets including a first set containing information on a first segment of the N-bit binary numbers and a second set containing information on a second segment of the N-bit binary numbers, each the set of the at least two sets of inputs including: (A) a first input indicating an equality result, and (B) a second input indicating an inequality result; (ii) a processor having processing logic for examining and evaluating the information, so as to provide comparative information on at least a portion of each of the N-bit binary numbers, the comparative information including a produced equality result and a produced inequality result and (iii) a set of outputs containing the comparative information, the set of outputs including: (A) a first output indicating the produced equality result, and (B) a second output indicating the produced inequality result.

According to yet another aspect of the present invention there is provided a method for comparing two N-bit binary numbers, the method including the steps of: (a) splitting each of the N-bit binary numbers into at least two segments, wherein N is an integer greater than 1; (b) providing a comparator device including: (i) a plurality of computer implemented comparator units, each of the comparator units having: (A) at least two inputs containing information on a first segment of the segments, (B) processing logic for examining and evaluating the information, so as to provide comparative information on at least the first segment, the comparative information including at least one result selected from the group consisting of a produced equality result and a produced inequality result and (C) at least one output containing the result, wherein a first plurality of the comparator units is logically disposed in parallel with respect to one another, and wherein at least a second plurality of the comparator units is logically disposed in series with respect to one another, and (c) comparing the segments using the processing logic to produce the result.

The present invention successfully addresses the performance limitations of the existing comparator designs by providing a system and method for performing parallel operations within comparators to significantly reduce the comparator time delay.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of a Single-Stage Comparator of the prior art;

FIG. 2 is a block diagram of a Two-Stage Comparator having two pairs of inputs, according to one embodiment of the present invention;

FIG. 3 is a block diagram of a Two-Stage Comparator having three pairs of inputs;

FIG. 4 is a block diagram of a Three-Stage Comparator according to another embodiment of the present invention;

FIG. 5 is a block diagram illustrating the first three stages of a Multi-Stage Ultra Fast Comparator (UFC);

FIG. 6 is a block diagram illustrating the last three stages of a Multi-Stage UFC;

FIG. 7 is a block diagram illustrating a Multi-Stage UFC for input numbers having N bits that are not powers of 2;

FIG. 8 is a block diagram illustrating a 7-bit UFC, and

FIG. 9 is an exemplary block diagram illustrating a 7-bit UFC for the specific input values A=1011010 and B=1001101.

### DESCRIPTION OF THE PREFERRED EMBODIMENTS

The present invention is an ultra-fast comparator and method for utilizing such a comparator so as to boost processing performance, while maintaining modest hardware requirements.

The principles and operation of the ultra-fast comparator according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

The comparator of the present invention can be advantageously integrated, inter alia, into various row and column locators to perform fast Search operations and efficient Insert and Remove operations to keep the lists of the keys and their associated data in perfect sequence. The comparator is particularly suitable for incorporation within devices disclosed in some of my previous patent applications, such as the Binary Content Addressable Memory device taught by U.S. patent application Ser. No. 10/229,054 and the RAM-Based Range Content Addressable Memory device taught by U.S. patent application Ser. No. 10/229,065. Both of these applications are incorporated by reference for all purposes as if fully set forth herein.

The purpose of the Ultra Fast Comparator (UFC) is to compare two binary numbers of N bits and issue as a result two outputs, EQ (equal) and GT (greater than); these outputs may assume the values “1” (“true”) or “0” (“false”), which uniquely determine whether these numbers are equal, or, if they are different, which of the numbers is larger. One of the main concepts behind the UFC is the recursive splitting of the two N-bit numbers by division by prime numbers M₁, M₂, . . . , Mₘ (provided they are submultiples of N) into groups of decreasing number of bits to obtain a set of M (=M₁·M₂· . . . ·Mₘ) numbers of N/M bits, which can be compared in parallel. For this purpose, the single comparator of N bits is split recursively by division by the integers M₁, M₂, . . . ,Mₘ, into groups of comparator units of decreasing number of input bits to obtain a set of M (=M₁·M₂· . . . ·Mₘ) comparator units of N/M input bits that operate in parallel as a first stage. The outputs of the M comparator units are recursively connected in subsequent m+1 stages with decreasing number of comparator units until reaching a single comparator unit that issues two 1-bit outputs EQ and GT, which uniquely determine the relationship between the values of the two input N-bit numbers. All the comparator units of each stage operate in parallel providing overall time-efficient operation.

A preferable design is achieved when M=N, resulting in N 1-bit comparator units in the first stage operating in parallel and recursively connected in subsequent stages with decreasing number of comparator units.

In the simplest and most efficient design, N=2ⁿ, M₁=M₂= . . . =Mₘ=2, such that M=2^{m}. Optimally, m=n, such that M=N, resulting in N 1-bit comparator units in the first stage operating in parallel and recursively connected in pairs to half the number of comparator units in subsequent n+1 stages up to a single 1-bit comparator unit in the last stage that issues two 1-bit outputs EQ and GT, which uniquely determine the relative size of the two input N-bit numbers.

The multi-stage architecture with a plurality of 1-bit comparator units in the first stage operating in parallel leads to a much faster operation and is also efficient in terms of the hardware requirement. Since the optimal multi-stage comparator for two input numbers whose number of bits is N=2ⁿ has n+1 stages, where n=log₂ N, and all the comparator units in each stage operate in parallel, then the propagation time through the UFC is proportional to n+1=log₂ N+1. The total number of comparator units in the UFC is 2·N−1.

The optimal multi-stage architecture for N=2ⁿ can be extended to structures in which the input numbers have any number of bits N that are not powers of 2 (2ⁿ⁻¹<N<2ⁿ), and can be represented by the sum of terms

N=Nₙ₋₁·2ⁿ⁻¹+Nₙ₋₂·2ⁿ⁻²+ . . . +N₁·2¹+N₀.

The two input N-bit numbers A and B are split into N single-bit numbers, and the N pairs of single-bit numbers are compared using N parallel comparator units in the first stage. Each set of K (=2^{k}) pairs of single-bit numbers corresponding to each term of the form Nₖ·2^{k} (in the above expression for N) is handled by a comparator block having K 1-bit comparator units in its first stage and k+1 stages. The outputs of the n comparator blocks corresponding to the n terms can be recursively connected to 4-input 1-bit comparator units, starting from the smallest block (No. 0) with one stage, up to the largest block (No. n−1) having n stages. The output of any generic (k−1)-th comparator block (with k stages) is connected to a 4-input comparator unit that is in turn connected, with the output of the next (k-th) comparator block (with k+1 stages), to the next 4-input comparator unit. Finally, the (n−2)-th block is connected to a 4-input comparator unit that is in turn connected with the largest, (n−1)-th, block to the last 4-input comparator unit to conform a UFC with n+1 stages. The EQ and GT outputs of the 4-input comparator unit in the last stage specify the relative value of the input numbers A and B.

In this way, the optimal multi-stage UFC architecture is extended to structures in which 2ⁿ−1<N<2ⁿ by suitable arrangement of the comparator units in blocks and connections of the block outputs using 4-input comparator units; these UFC structures consist of n+1 stages, where n=log₂ N; hence, the UFC propagation time is proportional to n+1=log₂ N+1 (as for N=2ⁿ).

The total number of comparator units in the UFC for 2ⁿ⁻¹<N<2ⁿ depends on the specific number of bits N, which determines the required number of comparator blocks and comparator units.

Comparator Definition

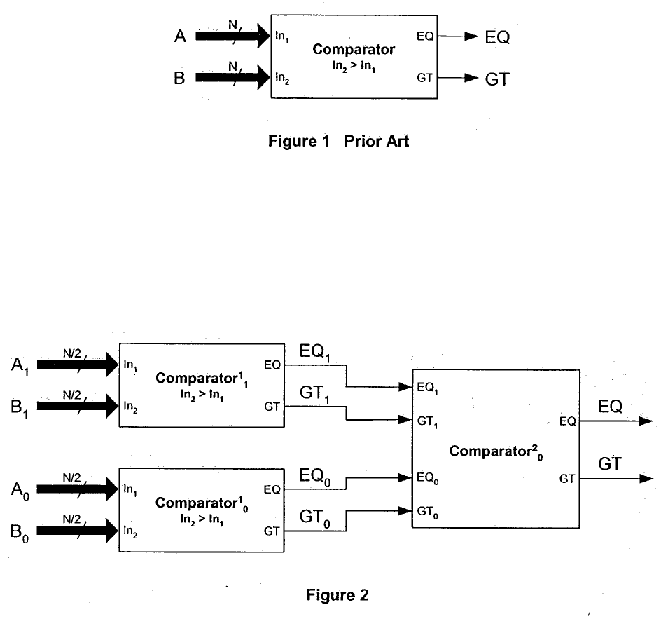

The Ultra Fast Comparator (UFC) compares two N-bit binary numbers, and subsequently issue two outputs, EQ (equal) and GT (greater than). These outputs may assume the values “1” (“true”) or “0” (“false”) that uniquely determine whether these numbers are equal, or, if they are different, which of them is larger. FIG. 1 shows a basic block diagram of the comparator and Table 1 lists the relationship between the values of the two input binary numbers A and B, and the comparator outputs EQ and GT.

TABLE 1
Relationship Between the Input and Output Values
of the Single-Stage Comparator

| | |
|---|---|
| Input | Comparator Outputs |

| Numbers | EQ | GT |
|---|---|---|
| A < B | 0 | 1 |
| A > B | 0 | 0 |
| A = B | 1 | 0 |

Table 2 provides the truth table for the comparator inputs and outputs when A and B are 1-bit numbers; these relations can be equivalently stated by the following logic equations:

EQ=A·B+NOT(A)·NOT(B) (1)

GT=NOT(A)·B (2)

TABLE 2
Truth Table for the Input and Output Values
of the Single-Stage 1-bit Input Comparator

| | |
|---|---|
| Input Numbers | Comparator Outputs |

| A | B | EQ | GT |
|---|---|---|---|
| 0 | 0 | 1 | 0 |
| 0 | 1 | 0 | 1 |
| 1 | 0 | 0 | 0 |
| 1 | 1 | 1 | 0 |

Comparator Structure and Principles of Operation

The main concept of the UFC is the recursive splitting of the two input N-bit numbers into groups of decreasing number of bits by dividing N by prime numbers M₁, M₂, . . . , Mₘ, where M₁≧M₂≧ . . . ≧Mₘ (provided that they are submultiples of N), to obtain a set of M (=M₁·M₂· . . . ·Mₘ) numbers of N/M bits, which can be compared in parallel. The hardware architecture for implementing this concept is obtained by recursively splitting the single N-bit comparator by division by the integers M₁, M₂, . . . Mₘ, into groups of decreasing number of input bits to obtain a set of M (=M₁·M₂· . . . ·Mₘ) comparator units of N/M input bits that operate in parallel as a first stage. This splitting can be performed by directing, in orderly fashion, each of the M groups of N/M input bits to the input of a different comparator unit of the set of M comparator units. These groups of bits are generally carried by a bus, register or any type of memory. The outputs of the M comparator units are recursively connected in subsequent m+1 stages with decreasing number of comparator units until reaching a single comparator unit that issues two 1-bit outputs, EQ and GT, which uniquely determine the relationship between the values of the two input N-bit numbers, as defined by Table 1.

A preferable design is achieved when M=N, resulting in N 1-bit comparator units in the first stage operating in parallel and recursively connected in subsequent stages with decreasing number of comparator units.

In the simplest and most efficient design, N=2ⁿ, M₁=M₂= . . . =Mₘ=2, such that M=2^{m}. Optimally, m=n, such that M=N, resulting in N 1-bit comparator units in the first stage operating in parallel and recursively connected in pairs to half the number of comparator units in subsequent n+1 stages up to a single 1-bit comparator unit in the last stage that issues two 1-bit outputs, EQ and GT, which uniquely determine the relative size of the two input N-bit numbers.

Two-Stage Comparator

The simplest structure of a comparator with more than one stage results from splitting each of the two input N-bit numbers A and B into two N/2-bit numbers, (provided that N is a multiple of 2) and the corresponding splitting of the single-stage N-bit comparator shown in FIG. 1 and defined by Table 1 into two comparator units of N/2 bits operating in parallel; the outputs of these comparator units are connected to a single 1-bit comparator unit issuing two single outputs, EQ and GT, so as to specify the relative value of the two input numbers. The two-stage comparator is shown in FIG. 2. A₁ and B₁ represent the N/2 more significant bits (MSBs) of the input numbers A and B; A₀ and B₀ represent the N/2 less significant bits (LSBs). Comparator¹₁ and Comparator¹₀ are used in the first stage (stage 1) to compare the MSBs (A₁ and B₁) and LSBs (A₀ and B₀), respectively, of the two input numbers A and B. Comparator²₀ is used in the second stage (stage 2) to compare the outputs of the two comparator units of the previous stage.

Table 3 defines the relations between the input numbers and the output values of the comparator units in the first and second stage; the relations between the output values of the comparator units in the first and second stage can be equivalently stated by the following logic equations:

EQ=EQ₁·EQ₀ (3)

GT=GT₁+EQ₁·GT₀ (4)

TABLE 3
Relationship Between the Input and Output Values
of the Two-Stage Comparator with Two Inputs

| | | | | | | | 2^{nd}-Stage | |
|---|---|---|---|---|---|---|---|---|
| | | | | | | | Comp. | |
| Input Numbers | | | 1^{st}-Stage Comp. Outputs | | | | Outputs | |
| A vs B | A₁ vs B₁ | A₀ vs B₀ | EQ₁ | GT₁ | EQ₀ | GT₀ | EQ | GT |
| A < B | A₁ < B₁ | X | 0 | 1 | X | X | 0 | 1 |
| | A₁ = B₁ | A₀ < B₀ | 1 | 0 | 0 | 1 | 0 | 1 |
| A > B | A₁ > B₁ | X | 0 | 0 | X | X | 0 | 0 |
| | A₁ = B₁ | A₀ > B₀ | 1 | 0 | 0 | 0 | 0 | 0 |
| A = B | A₁ = B₁ | A₀ = B₀ | 1 | 0 | 1 | 0 | 1 | 0 |

Where X means don't care

The two-stage comparator shown in FIG. 2 and defined by Table 3 can be used to compare, for instance, two 10-bit numbers A and B by dividing them into two 5-bit numbers and splitting a single-stage 10-bit comparator into two 5-bit comparator units operating in parallel; the outputs of these comparator units can be connected to a single 1-bit comparator unit whose outputs EQ and GT specify the relative value of the two input numbers.

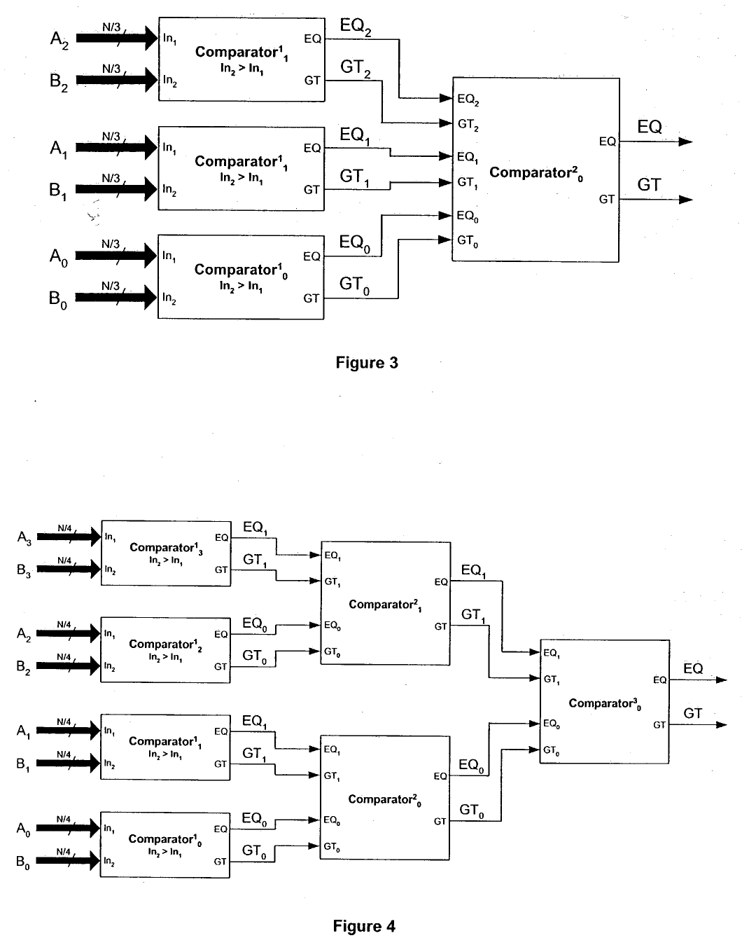

A less simple structure of a two-stage comparator results from splitting each of the two input N-bit numbers A and B into three N/3-bit numbers (provided that N is a multiple of 3) and, correspondingly, splitting the single-stage N-bit comparator (shown in FIG. 1) into three comparator units of N/3 bits operating in parallel. The outputs of these comparator units are connected to a single 1-bit comparator unit issuing two single outputs EQ and GT, which specify the relative value of the two input numbers. The two-stage comparator with three inputs is shown in FIG. 3. A₂ and B₂ represent the N/3 more significant bits (MSBs) of the input numbers A and B; A₀ and B₀ represent the N/3 less significant bits (LSBs). Comparator¹₁ and Comparator¹₀ are used in the first stage (stage 1) to compare the MSBs (A₂ and B₂) up to the LSBs (A₀ and B₀), respectively, of the two input numbers A and B. Comparator²₀ is used in the second stage (stage 2) to compare the outputs of the two comparator units of the previous stage.

Table 4 defines the relations between the input numbers and the output values of the comparator units in the first and second stage; the relations between the output values of the comparator units in the first and second stage can be equivalently stated by the following two logic equations, which represent an extension of the logic equations (3) and (4) for three comparator units in the first stage:

EQ=EQ₂·EQ₁·EQ₀ (5)

GT=GT₂+EQ₂·GT₁+EQ₂·EQ₁·GT₀ (6)

TABLE 4
Relationship Between the Input and Output Values of the
Two Stage Comparator with Three Inputs

| | | | | | | | | | | 2^{nd}-Stage | |
|---|---|---|---|---|---|---|---|---|---|---|---|
| Input Numbers | | | | 1^{st}-Stage Comp. Outputs | | | | | | Comp. Outputs | |
| A vs B | A₂ vs B₂ | A₁ vs B₁ | A₀ vs B₀ | EQ₂ | GT₂ | EQ₁ | GT₁ | EQ₀ | GT₀ | EQ | GT |
| A < B | A₂ < B₂ | X | X | 0 | 1 | X | X | X | X | 0 | 1 |
| | A₂ = B₂ | A₁ < B₁ | X | 1 | 0 | 0 | 1 | X | X | 0 | |
| | A₂ = B₂ | A₁ = B₁ | A₀ < B₀ | 1 | 0 | 1 | 0 | 0 | 1 | 0 | 1 |
| A > B | A₂ > B₂ | X | X | 0 | 0 | X | X | X | X | 0 | 0 |
| | A₂ = B₂ | A₁ > B₁ | X | 1 | 0 | 0 | 0 | X | X | 0 | 0 |
| | A₂ = B₂ | A₁ = B₁ | A₀ > B₀ | 1 | 0 | 1 | 0 | 0 | 0 | 0 | 0 |
| A = B | A₁ = B₁ | A₁ = B₁ | A₀ = B₀ | 1 | 0 | 1 | 0 | 1 | 0 | 1 | 0 |

Where X means don't care

The two-stage comparator shown in FIG. 3 and defined by can be used to compare, for instance, two 15-bit numbers A and B by dividing them into three 5-bit numbers and splitting a single-stage 15-bit comparator into three 5-bit comparator units operating in parallel; the outputs of these comparator units can be connected to a single 1-bit comparator unit whose outputs, EQ and GT, specify the relative value of the two input numbers.

If N is a multiple of any prime number P larger than 2 and 3, the two input N-bit numbers A and B can split into P numbers with N/P bits, and the single-stage N-bit comparator can be split into P comparator units for N/P bits, similar to those shown in FIGS. 2 and 3. This requires the extension of the relations between the output values of the first and second stage comparator units, defined by Table 3, and equivalently stated by the logic equations (3) and (4), for two comparator units in the first stage, and similarly, by Table 4 and logic equations (5) and (6), for three comparator units. The outputs of the P comparator units are connected to a single 1-bit comparator unit issuing two single outputs, EQ and GT, which specify the relative value of the two input numbers.

The implementation of a two-stage comparator by recursive splitting of each of the two input N-bit numbers into two N/2-bit numbers and recursive splitting of the single-stage N-bit comparator into two N/2-bit comparator units is the most efficient; recursive splitting by division by 3 (provided that N is a multiple of 2 and 3) or any larger number results in larger number of serial operations and longer propagation time.

Three-Stage Comparator

The simplest structure of a three-stage comparator results from splitting each of the input numbers A and B into four N/4-bit numbers, and the corresponding splitting of the single-stage N-bit comparator shown in FIG. 1 and defined by Table 1 into four comparator units of N/4 bits operating in parallel (FIG. 4). The outputs of these four N/4-bit comparator units of the first stage are connected to two 1-bit comparator units in a second stage. Each of these comparator units issues two single outputs EQ and GT that are connected to a single 1-bit comparator unit (in a third stage), whose outputs EQ and GT specify the relative value of the input numbers. Inputs A₃ and B₃ in this three-stage comparator (FIG. 4) represent the N/4 more significant bits (MSBs) of the input numbers A and B; A₀ and B₀ represent the N/4 less significant bits (LSBs). Comparator¹₃ to Comparator¹₀ are used in the first stage to compare the MSBs (A₃ and B₃) down to the LSBs (A₀ and B₀), respectively, of the two input numbers A and B; these comparator units comply with the relations between the input numbers and the output values defined by Table 1.

Each of the Comparator²₁ and Comparator²₀ in the second stage are used to compare the outputs of two comparator units of the first stage. Comparator³₀ is used in the third stage to compare the outputs of the two comparator units of the second stage. Comparator²₁, Comparator²₀ and Comparator³₀ comply with the relations between the input and output values as stated by the logic equations (3) and (4).

If N is a multiple of P₁·P₂, where P₁ and P₂ are two prime numbers larger than 2, the two input N-bit numbers A and B can be split into P₁·P₂ numbers with N/(P₁·P₂) bits, and the single-stage N-bit comparator can be split into P₁·P₂ comparator units for N/(P₁·P₂) bits in the first stage, similar to those shown in FIG. 4 (for P₁=P₂=2). The P₁·P₂ comparator units can be divided in P₁ sets of P₂ comparator units, where the outputs of each set are connected to the inputs of one comparator unit in the second stage; this stage consists of P₁ comparator units having 2-P² inputs. The outputs of the P₁ comparator units are connected to the inputs of a single comparator unit in the third stage. This arrangement requires the extension of the relations between the output values of the comparator units in the first stage and second stage, defined by Table 3, and equivalently stated by the logic equations (3) and (4), for two comparator units in the first stage, and similarly, by Table 4 and logic equations (5) and (6), for three comparator units.

General Multiple-Stage Comparator

A very efficient implementation is obtained by recursively splitting by 2 each of the input N-bit numbers A and B m times into M=2^{m} numbers of N/M bits (provided that N is a multiple of 2^{m}), and correspondingly splitting the single N-bit comparator into M 2-input comparator units of N/M bits operating in parallel, to conform the first stage of a UFC with m+1 stages.

The implementation of a comparator by recursive splitting into any prime numbers larger than 2 (provided that N is a multiple of these prime numbers) appears to be less efficient in terms of speed and number of components.

The optimal multi-stage architecture is obtained by recursively splitting by 2 each of the input N-bit numbers A and B n times into N (=2ⁿ) 1-bit numbers (provided that N=2ⁿ), and recursively splitting the single N-bit comparator is into N 1-bit comparator units (with two inputs), which operate in parallel and conform the first stage of a UFC with n+1 stages, where n=log₂ N. Each comparator unit of the first stage issues two 1-bit outputs EQ and GT related to the input 1-bit numbers as defined by Table 1 and equivalently stated by the logic equations (1) and (2).

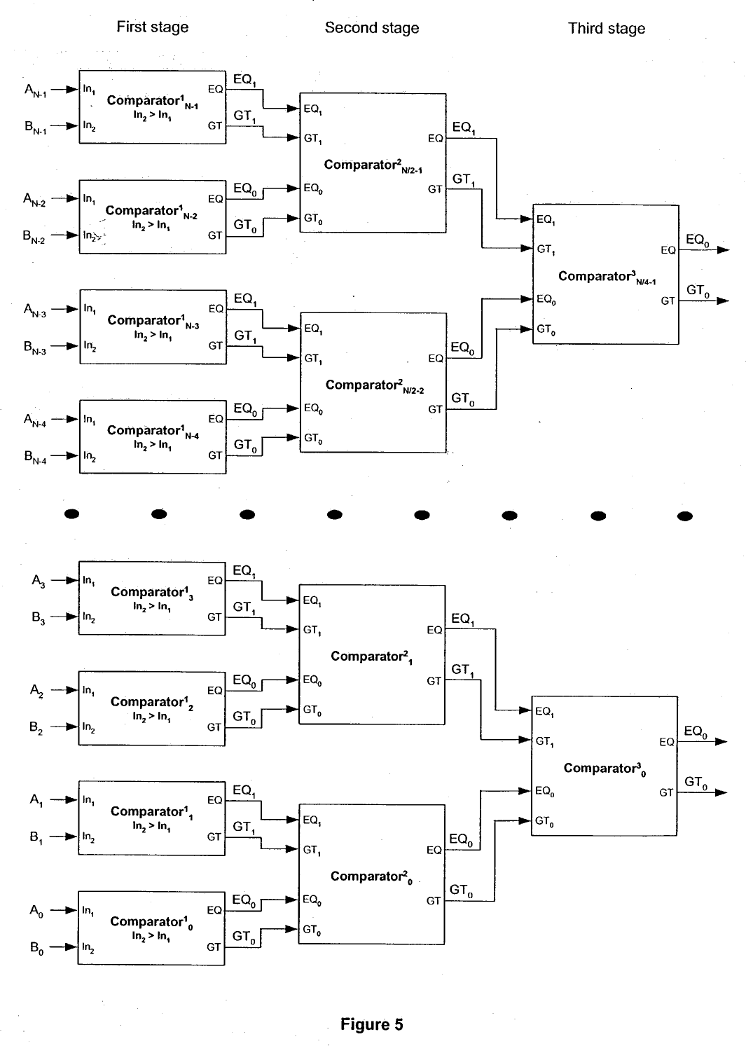

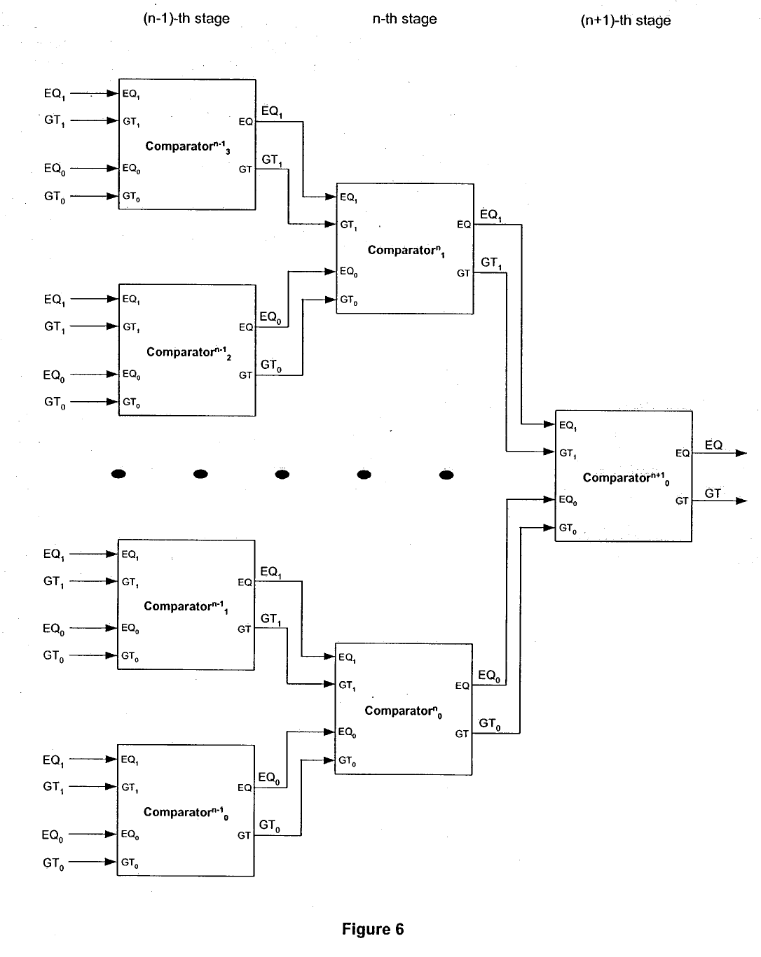

FIGS. 5 and 6 show the three first and three last stages, respectively, in a block diagram of this UFC. The outputs of every pair of first stage comparator units are connected to a single 1-bit comparator unit in the second stage. Thus, the outputs of the N comparator units of the first stage are connected in pairs to N/2 1-bit comparator units in a second stage. Each of the N/2 comparator units of the second stage issues two single outputs EQ and GT that are connected in pairs to a single 1-bit comparator unit in a third stage. The EQ and GT outputs of the N/4 comparator units in the third stage are connected to in pairs to N/8 1-bit comparator units in a fourth stage, and so on. The (n−1)-th stage consists of four 1-bit comparator units whose outputs are connected to two 1-bit comparator units in the n-th stage (one before last). The n-th stage includes two 1-bit comparator units whose outputs are connected to a single 1-bit comparator unit in the (n+1)-th stage; the EQ and GT outputs of this last comparator unit specify the relative value of the input numbers A and B. The input and output values of the 4-input comparator units used in all the UFC stages, except the first, are related as defined by Table 3, and equivalently stated by the logic equations (3) and (4).

The optimal multi-stage architecture shown in FIGS. 5 and 6 can be extended to structures in which the input numbers have a number of bits N that is not a power of 2(2ⁿ⁻¹<N<2ⁿ), and can be represented by the sum of terms

N=Nₙ₋₁·2ⁿ⁻¹+Nₙ₋₂·2ⁿ⁻²+ . . . +N₁·2¹+N₀.

The two input N-bit numbers A and B are split into N single-bit numbers, and the N pairs of single-bit numbers are compared using N parallel comparator units in the first stage. Each set of K (=2^{k}) pairs of single-bit numbers corresponding to each term of the form Nₖ·2^{k} (in the above expression for N) is handled by a comparator block having K 1-bit comparator units in its first stage and k+1 stages.

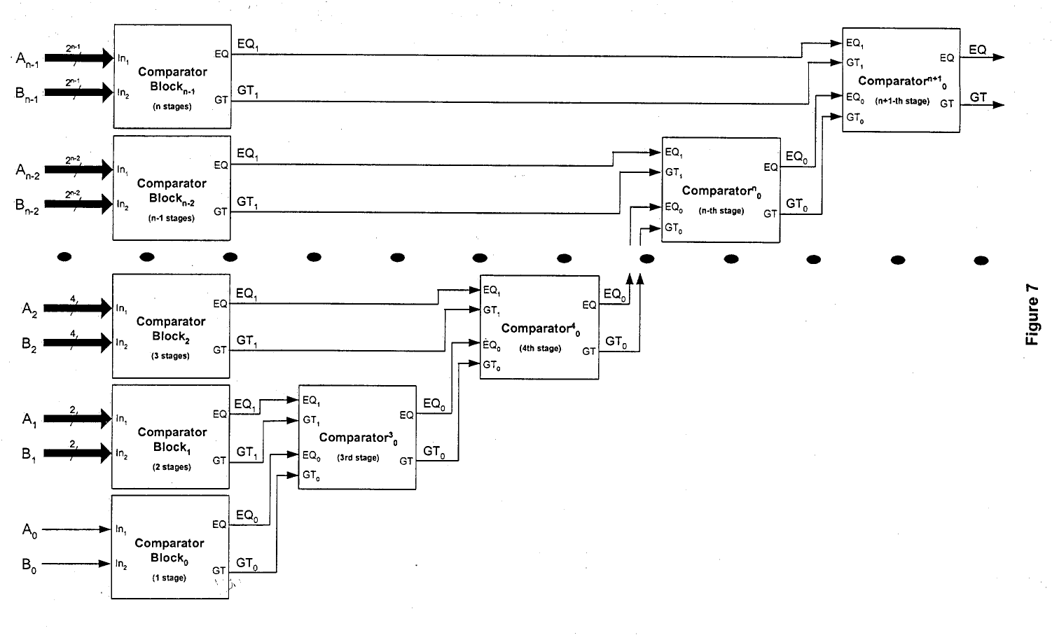

The comparator block is structured as shown in FIGS. 5 and 6 for the three first and three last stages, respectively. The outputs of the n comparator blocks corresponding to the n terms can be recursively connected to 4-input 1-bit comparator units, starting from the smallest block (No. 0) with one stage, up to the largest block (No. n−1) with n stages. FIG. 7 shows the first and last comparator blocks of a multi-stage UFC for input numbers with a number N of bits that is not a power of 2 (2ⁿ⁻¹<N<2ⁿ). The output of any generic (k−1)-th comparator block (with k stages) is connected to a 4-input comparator unit that is in turn connected, with the output of the next (k-th) comparator block (with k+1 stages), to the next 4-input comparator unit. Finally, the (n−2)-th block is connected to a 4-input comparator unit that is in turn connected with the largest, (n−1)-th, block to the last 4-input comparator unit to conform a UFC with n+1 stages, where n =log₂ N. The EQ and GT outputs of the 4-input comparator unit in the last stage specify the relative value of the input numbers A and B.

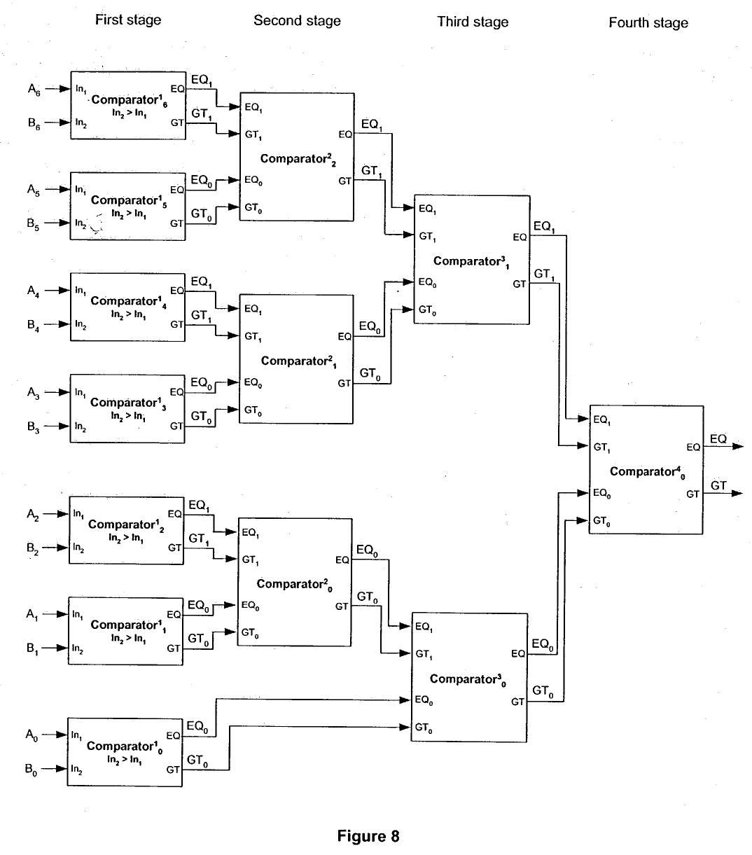

FIG. 8 shows an example of a UFC designed with 1-bit comparator units for comparing two input numbers A and B with 7 bits (N=1·2²+1·2¹+1=4+2+1=7). The UFC is implemented in four stages. The first stage consists of 7 comparator units arranged so that the first 4 are used to compare the 4 MSBs of A and B, the next 2 are used to compare the following 2 bits, and the last comparator unit compares the LSBs of A and B.

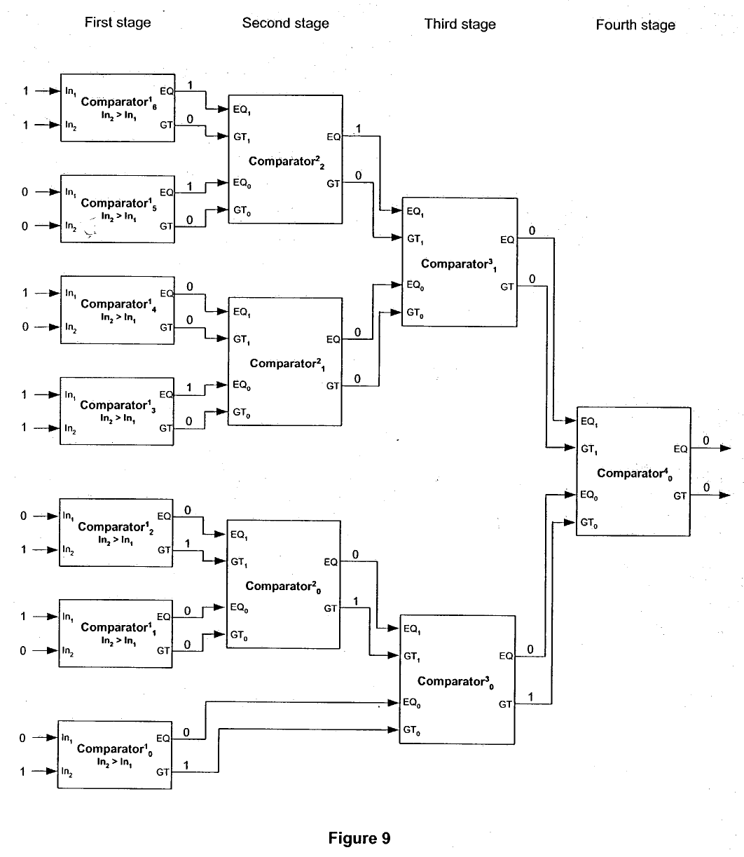

FIG. 9 shows the UFC depicted in FIG. 8 for the specific input values A=1011010 and B=1001101. The relationship between the input and output values of each 2-input comparator unit in the first stage in these figures is defined by Table 1 and equivalently stated by the logic equations (1) and (2). The input and output values of the 4-input comparator units used in all the succeeding UFC stages are related as defined by Table 3, and equivalently stated by the logic equations (3) and (4).

Performance Factors

FIGS. 5 and 6 show the optimal multi-stage UFC for comparing two input numbers A and B whose number of bits N is a power of 2 (N=2ⁿ); this UFC has n+1 stages, where n=log₂ N. The UFC has N 2-input comparator units in the first stage and (N−1) 4-input comparator units in the other n stages.

If the propagation time through each 2-input comparator unit is represented by T₁ and the propagation time through each 4-input comparator unit is T₂, then, since all the comparator units in each stage operate in parallel, the propagation time through the first stage is T₁ and through the remaining n stages is n·T₂. Thus, the total number of comparator units in the UFC is 2·N−1, and the total propagation time is T=T₁+n·T₂=T₁+(log₂ N)·T₂.

If the number of bits N is not a power of 2 (2ⁿ⁻¹<N<2ⁿ), it can be represented by the sum of terms N=Nₙ₋₁·2ⁿ⁻¹+Nₙ₋₂·2ⁿ⁻²+ . . . +N₁·2¹+N₀. The two input N-bit numbers A and B are split into N single-bit numbers, and the N pairs of single-bit numbers are compared using N parallel comparator units in the first stage. Each set of K (=2^{k}) pairs of single-bit numbers corresponding to each term of the form Nₖ−2^{k} (in the above expression for N) is handled by a comparator block having K 1-bit comparator units in its first stage and k+1 stages.

The optimal multi-stage UFC for comparing these two input numbers is shown in FIG. 7. The output of a generic (k−1)-th comparator block (with k stages) is connected to a 4-input comparator unit that is in turn connected, with the output of the next (k-th) comparator block (having k+1 stages), to the next 4-input comparator unit. Since the propagation time through the (k−1)-th comparator block (with k stages) is T=T₁+(k−1)·T₂, and the 4-input comparator unit at its output adds a propagation time T₂, then the 4-input comparator unit output is synchronized, at T=T₁+k·T₂, with the output of the k-th comparator block (with k+1 stages). In a similar way, the output of the largest, (n−1)-th, block (having n stages), is synchronized, at T=T₁+(n−1)·T₂, with the output of the 4-input comparator unit connected to the previous, (n−2)-th, block. Thus, the last 4-input comparator unit, connected to the n-th block, issues output signals at T=T₁+n·T₂, which is equal to the propagation time through an optimal UFC with n+1 stages (shown in FIGS. 5 and 6), used to compare two input numbers whose number of bits N is a power of 2 (N=2ⁿ). This total propagation time, T=T₁+n·T₂, holds for any multi-stage UFC designed to compare two input N-bit numbers for such that 2ⁿ⁻¹<N<2ⁿ. The total number of comparator units in the UFC depends on the specific number of bits N, which determines the required number of comparator blocks and comparator units.

As used herein in the specification and in the claims section that follows, the terms “inequality result”, “produced inequality result”, and the like refer to a comparison of two N-bit binary numbers in which the result indicates that the two numbers are not equal. The inequality result is a matter of convention, and can be either a greater than (GT) result, or a less than (LT) result.

As used herein in the specification and in the claims section that follows, the term “comparator block” refers to a processing structure for processing, in a first stage, K pairs of single-bit numbers, K being defined by the expression:

K=2^{k} wherein k is an integer ≧1,

and wherein comparator units are also configured in stages (in series), such that the outputs of each pair of comparator units in the first stage of the comparator block are connected to one comparator unit in the following stage of the block, and the outputs of each pair of comparator units in each following stage of the block are, in turn, connected to the inputs of a comparator unit in a succeeding stage, the block being completed when the last stage of the block produces two single-bit outputs.

Thus, the number of stages (S) is defined by:

S=k+1

wherein S is the number of stages within the comparator block.

As used herein in the specification and in the claims section that follows, the term “a plurality of comparator blocks” refers to two or more comparator blocks, wherein, for at least one of the blocks, k is an integer ≧2.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A multiple-stage comparator for comparing N-bit binary numbers, the comparator comprising:
(a) a device for splitting each of the N-bit binary numbers into at least two segments, wherein N is an integer greater than 1, and
(b) a plurality of computer implemented comparator units, each of said comparator units having:
(i) at least two inputs containing information on a first segment of said segments;
(ii) a processor having processing logic for examining and evaluating said information, so as to provide comparative information on at least said first segment, said comparative information including at least one result selected from the group consisting of a produced equality result and a produced inequality result, and
(iii) at least one output containing said result,
wherein a first plurality of said comparator units is logically disposed in parallel with respect to one another, and wherein at least a second plurality of said comparator units is logically disposed in series with respect to one another.

2. The multiple-stage comparator of claim 1, wherein said first plurality of said comparator units is logically disposed such that each of said first plurality of said comparator units handles a single bit of the N-bit binary numbers.

3. The multiple-stage comparator of claim 1, wherein a first stage of said comparator units is designed and configured to receive and compare said segments of the N-bit binary numbers, and wherein a second stage of said comparator units is designed and configured to receive said at least one output of said comparator units in said first stage.

4. The multiple-stage comparator of claim 1, wherein in at least a portion of said comparator units, said at least two inputs containing information on said first segment include at least:
(i) a first set of inputs containing information on said first segment of the N-bit binary numbers, and
(ii) a second set containing information on a second segment of the N-bit binary numbers,
each said set including:
(A) a first input indicating an equality result, and
(B) a second input indicating an inequality result,
and wherein said processing logic within said portion of said comparator units generates comparative information on at least a portion of each of the N-bit binary numbers, said comparative information including both a produced equality result and a produced inequality result, and
wherein said at least one output includes a first output indicating said produced equality result, and a second output indicating said produced inequality result.

5. The multiple-stage comparator of claim 1, wherein said first plurality of said comparator units is logically disposed such that each of said first plurality of said comparator units handles said segments of the N-bit binary numbers, each of said segments having a number of bits that is a submultiple of N.

6. The multiple-stage comparator of claim 3, wherein said splitting device is configured to split the two N-bit binary numbers into N single-bit numbers, so as to produce pairs of said single-bit numbers, each pair of said pairs being compared in parallel in said first stage.

7. The multiple-stage comparator of claim 4, wherein said segments are single-bit segments.

8. The multiple-stage comparator of claim 1, wherein N of the two N-bit binary numbers satisfies an equation:
N=2ⁿ,
wherein n is an integer greater than 1, and wherein outputs of two of said comparator units in a first stage are introduced to one of said comparator units in a following stage.

9. The multiple-stage comparator of claim 8, wherein said comparator units within the multiple-stage comparator are arranged such that a comparison of the two N-bit binary numbers is achieved in n+1 stages.

10. The multiple-stage comparator of claim 1, wherein N of the two N-bit binary numbers satisfies an equation:
2ⁿ⁻¹<N<2ⁿ,
wherein n is an integer greater than 1, and wherein N can be represented by a sum of terms:
N=Nₙ₋₁·2ⁿ⁻¹+Nₙ₋₂·2ⁿ⁻²+ . . . +N₁·2₁+N₀,
wherein at least two of said terms are non-zero, and wherein said comparator units within the multiple-stage comparator are arranged such that a comparison of the two N-bit binary numbers is achieved in n+1 stages.

11. The multiple-stage comparator of claim 10, wherein at least a plurality of said comparator units is arranged within at least one comparator block.

12. The multiple-stage comparator of claim 11, wherein said plurality of said comparator units is arranged within a plurality of comparator blocks.

13. The comparator device of claim 4, wherein said produced equality result is defined by:
EQ=EQ₁·EQ₀
wherein:
EQ is said produced equality result;
EQ₁ is said equality result of said first set of said inputs, and
EQ₀ is said equality result of said second set of said inputs.

14. The comparator device of claim 4, wherein said produced inequality result is defined by:
NEQ=NEQ₁+EQ₁·NEQ₀
wherein:
NEQ is said produced inequality result;
NEQ₁ is said inequality result of said first set of said inputs;
NEQ₀ is said inequality result of said second set of said inputs, and
EQ₁ is said equality result of said first set of said inputs,
wherein said first set corresponds with said first segment of the N-bit binary numbers and said second set corresponds with said second segment of the N-bit binary numbers, and wherein said first segment contains more significant bits with respect to said second segment.

15. The comparator device of claim 14, wherein said produced inequality result is a greater than (GT) result.

16. The comparator device of claim 14, wherein said produced inequality result is a less than (LT) result.

17. The comparator device of claim 4, wherein said at least two sets of inputs include at least three sets of inputs.

18. A comparator device for comparing two N-bit binary numbers, the device comprising:
(a) at least one computer implemented comparator unit having:
(i) at least two sets of inputs, each set of said sets containing information on a respective segment of the N-bit binary numbers, said sets including a first set containing information on a first segment of the N-bit binary numbers and a second set containing information on a second segment of the N-bit binary numbers, each said set of said at least two sets of inputs including:
(A) a first input indicating an equality result, and
(B) a second input indicating an inequality result;
(ii) a processor having processing logic for examining and evaluating said information, so as to provide comparative information on at least a portion of each of the N-bit binary numbers, said comparative information including a produced equality result and a produced inequality result, and
(iii) a set of outputs containing said comparative information, said set of outputs including:
(A) a first output indicating said produced equality result, and
(B) a second output indicating said produced inequality result.

19. The comparator device of claim 18, wherein said produced equality result is defined by:
EQ=EQ₁·EQ₀
wherein:
EQ is said produced equality result;
EQ₁ is said equality result of said first set of said inputs, and
EQ₀ is said equality result of said second set of said inputs.

20. The comparator device of claim 18, wherein said produced inequality result is defined by:
NEQ=NEQ₁+EQ₁·NEQ₀
wherein:
NEQ is said produced inequality result;
NEQ₁ is said inequality result of said first set of said inputs;
NEQ₀ is said inequality result of said second set of said inputs, and
EQ₁ is said equality result of said first set of said inputs,
and wherein said first segment contains more significant bits with respect to said second segment.

21. The comparator device of claim 20, wherein said produced inequality result is a greater than (GT) result.

22. The comparator device of claim 20, wherein said produced inequality result is a less than (LT) result.

23. The comparator device of claim 18, wherein said at least two sets of inputs includes at least three sets of inputs.

24. A method for comparing two N-bit binary numbers, the method comprising the steps of:
(a) splitting each of the N-bit binary numbers into at least two segments, wherein N is an integer greater than 1;
(b) providing a comparator device including:
(i) a plurality of computer implemented comparator units, each of said comparator units having:
(A) at least two inputs containing information on a first segment of said segments,
(B) processing logic for examining and evaluating said information, so as to provide comparative information on at least said first segment, said comparative information including at least one result selected from the group consisting of a produced equality result and a produced inequality result and
(C) at least one output containing said result,
wherein a first plurality of said comparator units is logically disposed in parallel with respect to one another, and wherein at least a second plurality of said comparator units is logically disposed in series with respect to one another, and
(c) comparing said segments using said processing logic to produce said result.
